(19) United States
(12) Patent Application Publication
(10) Pub. No.: US 2008/0209079 A1
(43) Pub. Date: Aug. 28, 2008

(54) PERSONAL INFORMATION COMMUNICATION DEVICE AND METHOD

(76) Inventor: Ty Joseph Caswell, Zimmerman, MN (US)

Correspondence Address: MERCHANT & GOULD PC, P.O. BOX 2903, MINNEAPOLIS, MN, 55402-0903, US

(21) Appl. No.: 12/024,349

(22) Filed: Feb. 1, 2008

Related U.S. Application Data
(60) Provisional application No. 60/892,062, filed on Feb. 28, 2007.

(51) Int. Cl. G06F 12/02

(52) U.S. Cl. 710/13

(57) ABSTRACT

Methods and systems for transmitting and receiving digital data are disclosed. One method includes aligning the secondary communication interface of a first USB memory device with the secondary communication interface of a second USB memory device. The method further includes triggering communication between the first and second communication devices. The method also includes retrieving information from a memory of a first USB memory device, and transmitting the information from the first USB memory device to the second USB memory device via the secondary communication interface.

### CROSS-REFERENCE TO RELATED APPLICATIONS

The present application claims priority to U.S. Provisional Patent Application No. 60/892,062, filed Feb. 28, 2007, the disclosure of which is hereby incorporated by reference in its entirety.

### TECHNICAL FIELD

The present disclosure relates to methods and apparatus for data transmission. More specifically, the present disclosure relates to communication of digitized personal information.

### BACKGROUND

Cellular phones, personal digital assistants, and other handheld electronics are often configured to hold a variety of personal data, such as medical records, addresses of contacts, and other information specific to that user. For a variety of reasons, users of handheld electronics desire to share this information with others, whether it is to exchange personal information or contacts with a business associate, pictures with friends, or medical information with health professionals.

One particular situation in which such a need is felt is in a business setting where two or more businesspeople exchange paper business cards. Each individual typically carries a sufficient number of business cards to provide one for each of the other individuals present. Following the exchange of business cards, the cards are often misplaced or damaged, inhibiting the ability for the receiving businessperson to contact the individual identified on the card. Alternatively, businesspeople manually enter information from the business cards into their electronic “address book”, which is an inefficiently repetitive process of transferring large numbers of these small volumes of information—particularly for salespeople or other businesspeople contacting a large number of others in a given day.

In other situations, text, pictures, sound files or other files are shared, such as among teenagers at school. The various types of files can correspond to assignments shared among a group, or can correspond to personal information owned and/or controlled by the student. Files shared among students may be used in computers or other systems, such as for playback or editing.

For these and other reasons, improvements are desired.

### SUMMARY

The above and other problems are solved in accordance with the present disclosure by the following:

In one aspect, a method of transmitting digital data between two USB memory devices each having a USB interface and a secondary communication interface is disclosed. The method includes aligning the secondary communication interface of a first USB memory device with the secondary communication interface of a second USB memory device. The method further includes triggering communication between the first and second communication devices. The method also includes retrieving information from a memory of a first USB memory device, and transmitting the information from the first USB memory device to the second USB memory device via the secondary communication interface.

In a second aspect, a personal data communication system is disclosed. The system includes a server communicatively connected to one or more computing systems, the server arranged to receive personal data. The system also includes a plurality of personal data communications devices. Each of the devices includes a memory, a USB interface, a secondary interface, separate from the USB interface, and a programmable circuit operatively connected to the memory, the USB interface, and the secondary interface. The programmable circuit is programmed to exchange reference data with another of the plurality of personal data communications devices using the secondary interface. The programmable circuit is also programmed to, upon connection to a computing system via the USB interface, communicatively connect to the server to access the personal data based on the reference data.

In a third aspect, a USB memory device is disclosed. The device includes a housing sized to fit in the hand of a user, a memory configured to store personal information, a USB interface, and a secondary interface, separate from the USB interface. The device further includes a programmable circuit operatively connected to the memory, the USB interface, and the secondary interface. The programmable circuit is programmed to transmit digital data via the secondary interface. The programmable circuit includes program instructions to retrieve personal information from the memory, convert the personal information to a digital data packet, and generate a communication signal using a communications protocol, the communication signal based on the digital data packet. The programmable circuit is further programmed to receive digital data via the secondary interface. The programmable circuit includes program instructions to sense a communication signal, translate the communication signal to a digital data packet using a communications protocol, convert the digital data packet to personal information, and to store the personal information in a collection of personal information stored in the memory.

In a fourth aspect, a handheld memory device is disclosed. The handheld memory device includes a housing sized to fit in the hand of a user, a memory configured to store personal information, an electrical interface connectable to a personal computer, and a secondary interface, separate from the electrical interface. The device further includes a programmable circuit operatively connected to the memory, the electrical interface, and the secondary interface. The programmable circuit is programmed to receive information, through the electrical interface, from a user relating to data to be included in a set of personal information stored in the memory. The programmable circuit is further programmed to transmit digital data via the secondary interface. The programmable circuit includes program instructions to retrieve the personal information from the memory, convert the personal information to a digital data packet, and generate a communication signal using a communications protocol, the communication signal based on the digital data packet. The programmable circuit is further programmed to receive digital data via the secondary interface. The programmable circuit includes program instructions to sense an communication signal, translate the audible signal to a digital data packet using a communications protocol, convert the digital data packet to second personal information relating to a user of a different handheld memory device, and store the second personal information in a collection of personal information stored in the memory.

In a fifth aspect, a method of transmitting and receiving digital data is disclosed. The method includes retrieving personal information from a memory of the handheld device, converting the personal information to a digital data packet, and generating a signal using a communications protocol based on the digital data packet. A complementary method for receiving data can include sensing a communication signal, translating the signal to a digital data packet using a communications protocol, converting the digital data packet to personal information, and storing the personal information in a collection of personal information.

### BRIEF DESCRIPTION OF THE DRAWINGS

FIG. 1 shows methods and systems for data receipt according to a possible embodiment of the present disclosure;

FIG. 2 shows methods and systems for data transmission according to a possible embodiment of the present disclosure;

FIG. 3 shows an exemplary communications network in which aspects of the present disclosure can be implemented;

FIG. 4A shows a second exemplary communications network in which aspects of the present disclosure can be implemented;

FIG. 4B shows a further exemplary communications network in which transferred files can be accessed;

FIG. 5 shows a schematic front plan view of an audible data communications device according to a possible embodiment of the present disclosure;

FIG. 6 shows a schematic front plan view of the audible data communications device of FIG. 5 with a protective cover removed;

FIG. 7 shows a schematic side plan view of the audible data communications device of FIG. 5;

FIG. 8A shows a front perspective view of a data communications device, with a cover removed, according to a further embodiment of the present disclosure;

FIG. 8B shows a front perspective view of the data communications device of FIG. 8A with cover attached, according to a further embodiment of the present disclosure;

FIG. 8C shows an end plan view of the data communications device of FIG. 8A according to a further embodiment of the present disclosure;

FIG. 8D shows a side plan view of the data communications device of FIG. 8A with cover attached, according to a further embodiment of the present disclosure;

FIG. 8E shows a top plan view of the data communications device of FIG. 8A with cover attached, according to a further embodiment of the present disclosure;

FIGS. 9A and 9B show a perspective schematic view of two data communications devices interfacing, according to the embodiment shown in FIGS. 8A-8E;

FIG. 10A shows a front perspective view of a data communications device, with a cover removed, according to a further embodiment of the present disclosure;

FIG. 10B shows a front perspective view of the data communications device of FIG. 10A with cover attached, according to a further embodiment of the present disclosure;

FIG. 10C shows an end plan view of the data communications device of FIG. 10A according to a further embodiment of the present disclosure;

FIG. 10D shows a side plan view of the data communications device of FIG. 10A with cover attached, according to a further embodiment of the present disclosure;

FIG. 10E shows a top plan view of the data communications device of FIG. 10A with cover attached, according to a further embodiment of the present disclosure;

FIGS. 11A and 11B show a perspective schematic view of two data communications devices interfacing, according to the embodiment shown in FIGS. 10A-10E;

FIGS. 12A and 12B show a perspective schematic view of opposing sides of a printed circuit board useable in the systems shown in FIGS. 5-11;

FIG. 13 is an exemplary schematic of the circuitry of an audible data communications device according to a possible embodiment of the present disclosure;

FIG. 14 is a further schematic of circuitry of a data communications device according to a further possible embodiment of the present disclosure;

FIG. 15 shows an exemplary data packet communicated using the methods and systems described herein;

FIG. 16 shows a further exemplary data packet communicated using the methods and systems described herein;

FIG. 17 shows a further exemplary data packet communicated using the methods and systems described herein;

FIG. 18 illustrates interface circuitry for two communicating data communications devices, according to a possible embodiment of the present disclosure;

FIG. 19 illustrates a block of nonvolatile memory segmented into shared and private sectors, according to a possible embodiment of the present disclosure;

FIG. 20 illustrates an example user interface generated on a computing system for setting user information and file sharing information according to a possible embodiment of the present disclosure;

FIG. 21 illustrates an example user interface generated on a computing system interconnected with a data communications device according to the various embodiments of the present disclosure; and

FIG. 22 illustrates a flowchart of methods and systems for sharing data in a sector of memory of the various data communications devices of the present disclosure.

### DETAILED DESCRIPTION

Various embodiments of the present disclosure will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many embodiments possible.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

In general, the present disclosure relates to methods and systems for transfer of digital data, such as personal information. The methods and systems disclosed generate a signal, based on one or more communications protocols known in the art. The signal can be, in various embodiments, an audible signal, an optical signal, a radio signal, or a conducted electrical signal. The term audible signal as used herein relates to sounds emitted at a frequency within the audible range of a human listener, which do not form words of a user-recognizable language. The term optical signal as used herein relates to signals transmitted over optical communication means, such as through use of fiberoptic cables or free space optical transmission (e.g. infrared communication). The systems and methods can be implemented in a handheld device, such as a handheld memory device, cellular telephone, cordless telephone, personal digital assistant, or other portable electronic telecommunications device. A typical embodiment would be a handheld memory device, such as a USB memory device.

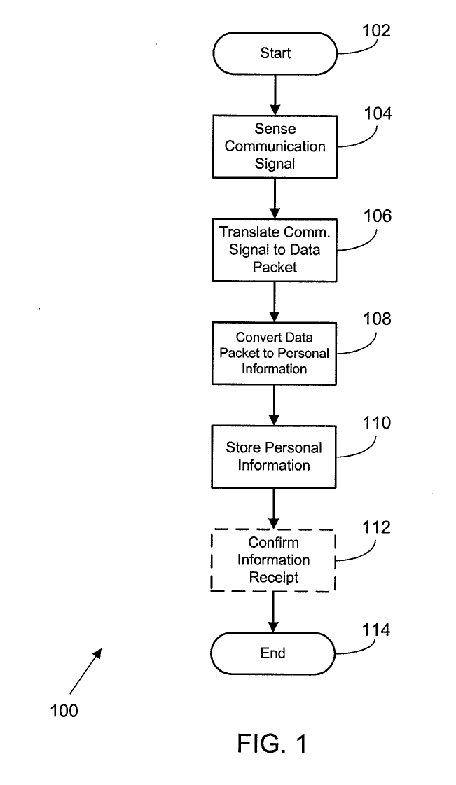

Referring now to FIG. 1, methods and systems for data receipt are shown according to a possible embodiment of the present disclosure. The system 100 shown operates to receive data, such as audibly emitted digital data carried on sound waves passing through the air or via some combination of wired speakers and air wave transmission. The system 100 can be embodied in any of a number of handheld devices, such as a credit card sized device, a miniature flash memory drive having a Universal Serial Bus (USB) interface, a cellular telephone, or some other mobile electronic device. In certain embodiments, the system as described is performed within a USB flash drive device.

The system 100 is instantiated at a start module 102. Operational flow proceeds to a sense module 104. The sense module 104 detects digital data embodied in a transmission medium. In certain embodiments, the transmission medium can be sound waves passing through the air, and can be implemented using a receiver and various analog and digital circuitry configured to filter out sounds of unwanted frequencies, preserving sounds within a frequency band in which data transmission is expected. In further embodiments, the transmission medium can be an infrared signal transmitted through the air, or an optical signal transmitted through a fiberoptic junction. Additionally, direct wired or radio frequency communication can be employed as well.

In a possible embodiment, data transmission within the system 100 occurs in all or part of the useable bandwidth from about 200 Hz to about 3400 Hz of standard POTS phone lines; alternately, all or a portion of the audible bandwidth of a cellular telephone transmission may be used. Other frequencies and ranges of frequencies are usable as well, and can be employed selectively based on the method and medium of transmission selected.

In a possible embodiment, the sense module 104 senses the presence of a data signal (e.g. sound waves in the case of audible transmission) and automatically reacts by activating the remainder of the modules in the system 100. In a further embodiment, a user activates the sense module 104 by pressing a button or otherwise activating the system 100. In such an embodiment, the sense module 104 begins attempting to sense transmitted digital data upon user activation.

Operational flow proceeds to a translation module 106. The translation module 106 translates the received signal to 1's and 0's, forming a data packet. The translation module 106 implements a communications protocol that relates the received signal to a digital representation of that signal. For example, the translation module 106 can translate digital data from an audible signal (sound wave), infrared signal (optical), wireless radio frequency signal, or direct wired analog signal. In certain embodiments, the communications protocol standardizes data transmission within the system 100 in all or part of the useable bandwidth from about 200 Hz to about 3400 Hz of standard POTS phone lines. In various other embodiments, the system 100 uses all or a portion of the audible bandwidth of a cellular telephone transmission.

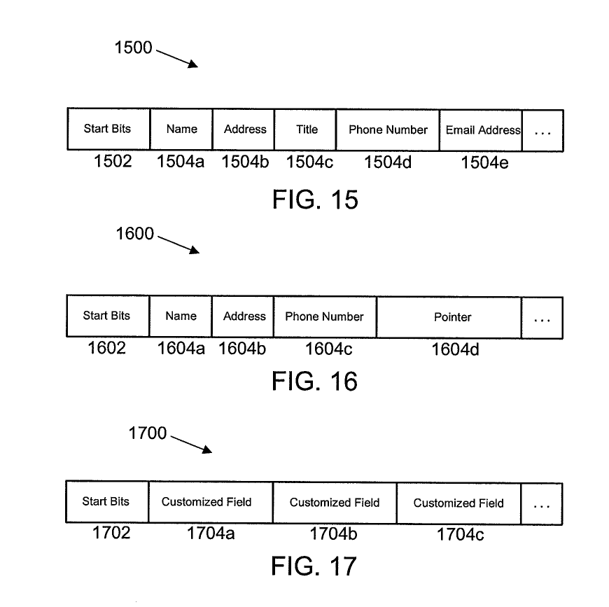

Operational flow proceeds to a conversion module 108. The conversion module 108 converts the digital bit stream to useable data. In a possible embodiment, the system 100 may be preconfigured to include a specified number of bits representing a first field, a second specified number of bits representing a second data field, and so on. In a further possible embodiment, a header data field specifies the number and length of the data fields. Example data fields are described below in conjunction with FIGS. 15-17.

Operational flow proceeds to a storage module 110. The storage module 110 stores the personal information in a memory of a handheld device. The storage module also optionally organizes various information received by the system 100 based on the type of information received as well as alphabetically or using some other organization system within each type of information. In various embodiments, the memory of the handheld device can be a flash memory or other persistent memory in which personal information is saved.

Operational flow proceeds to an optional confirmation module 112. The confirmation module 112 confirms to a user that the system 100 successfully acquired and stored data. The confirmation module 112 can do this in any of a number of ways. In one embodiment, the confirmation module 112 activates an indicator, such as a light emitting diode or other visible signal, which in turn notifies the user. In a further embodiment, the confirmation module 112 emits a readily recognizable audible sound that a user will recognize as indicating successful receipt of information. In such an embodiment, the audible sound may be implemented as a sound that is filtered by the sense module 104 such that a feedback loop is not created based on output of the sound, where sound waves are used for data transmission.

Operational flow terminates at an end module 114, which corresponds to completion of execution of the system 100.

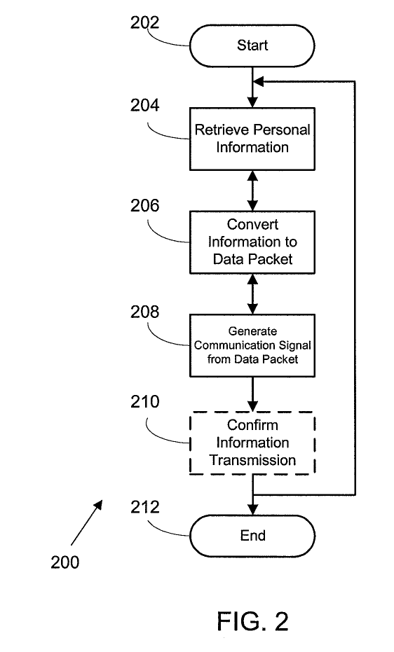

Referring now to FIG. 2, methods and systems for data transmission are shown according to a possible embodiment of the present disclosure. The system 200 shown, in general, performs the complementary function to the system 100 of FIG. 1, and is designed to prepare and transmit digital data using a selected transmission protocol and media, generally one complementary to the protocol and media used in the system of FIG. 1. For example, digital data can be prepared and transmitted at a variety of speeds and in a variety of formats on audible (sound) waves, optical signals, electrical signals, or radio frequency signals. The system 200 can therefore also be embodied in any of a number of handheld devices, as described above.

The system 200 is instantiated by a start module 202. The start module 202 corresponds to a user pressing a button or otherwise activating the handheld device, triggering the process to prepare and transmit data using a handheld device.

Operational flow proceeds to a retrieve module 204. The retrieve module 204 reads the memory of a handheld device and selects the information that the user desires to transmit to another device. The information can, for example, be business contact information typically found on a business card, or media files to be shared by friends and family. The information can also, be, for example, email messages, website addresses/links, credit card information, or multimedia files, including image or sound files. Other information can be retrieved as well, depending upon the types and file sizes of data stored on the handheld device, as well as the data transmission speed of the system 200.

Operational flow proceeds to a conversion module 206. The conversion module 206 forms the data retrieved from the memory of the handheld device into a data packet, as necessary for transmission under any applicable transmission protocol chosen. Exemplary data packets are shown below in FIGS. 15-17.

Operational flow proceeds to a generation module 208. The generation module converts the data packet into a signal embodied on the selected media of transmission. For example, the generation module 208 can transform the digital electrical signals of a device to the desired medium for transmission, such as an audible transmission, optical transmission, or electrical transmission. The generation module 208 performs the inverse operation of the translation module 106 of FIG. 1, in that it forms audible, optical, or other types of sounds based on data packets previously stored in a handheld device on which the system 200 operates.

Operational flow proceeds to an optional confirmation module 210. The confirmation module 210 optionally provides an indication to a user of a device in which the system 200 operates that data was successfully transmitted. The confirmation module 210 can do so, for example, by emitting a recognizable sound or activating an indicator such as a light emitting diode.

Operational flow terminates at an end module 212 that corresponds with completion of transmission of data and completion of execution of the system 200.

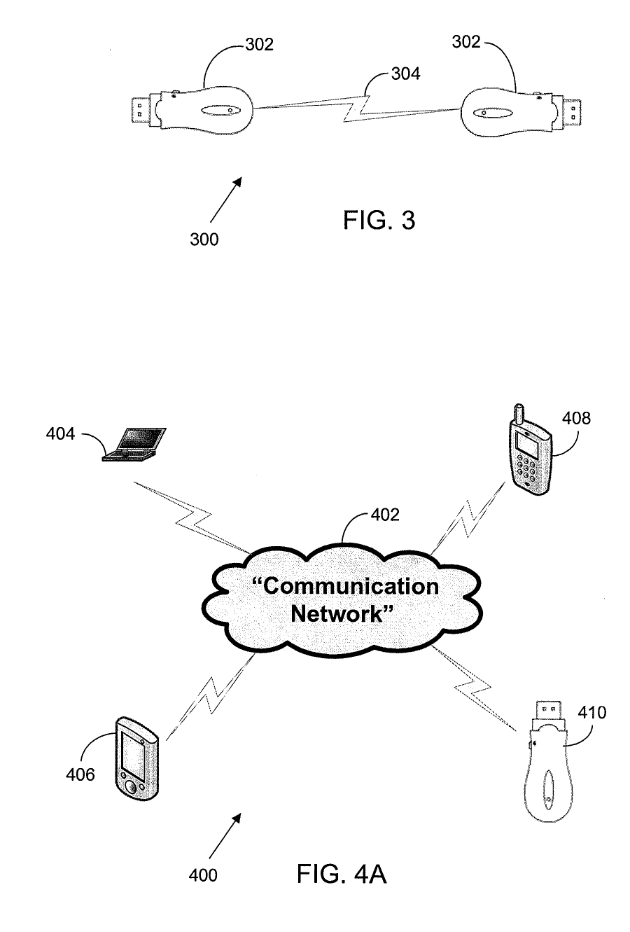

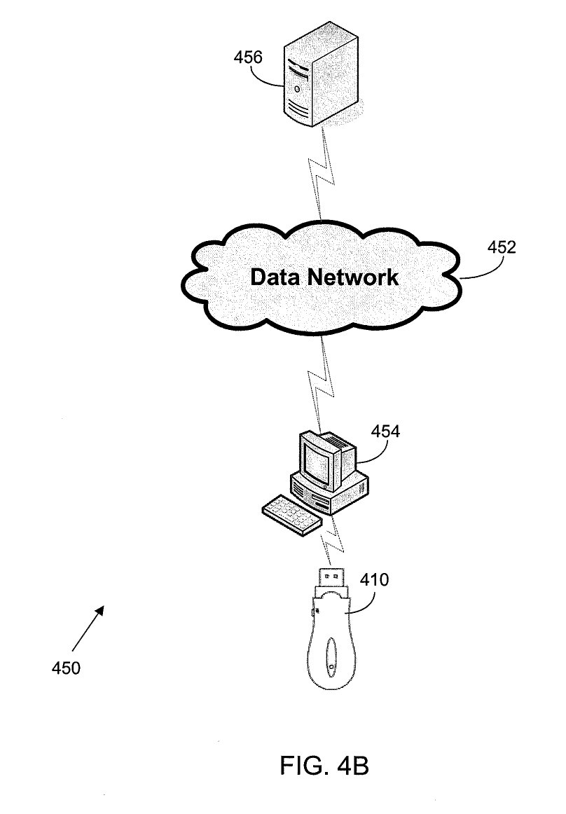

Now referring to FIG. 3, an exemplary communications network 300 is shown in which aspects of the present disclosure can be implemented. The network 300 includes two handheld devices 302 in bi-directional communications over a communication link 304. The handheld devices 302 are shown as two identical handheld devices, shown below in FIGS. 4-6. However, additional types of handheld devices can be used as well, and combinations of various types of handheld devices are possible.

The communications link 304 shown includes a sound wave, preferably traveling through air, over which audible communication of the digital data occurs. The communications link 304 can include various other wired or wireless data transmission methodologies upon receipt by other devices, such as by using various Internet or wireless transmission protocols known in the art. For example, the communications link 304 may include a sound wave transmitted from a first handheld device 302, which is in turn detected by an intermediate device, transduced to an electrical signal, then output as a sound wave at a separate location using a second transducer so as to be sensed and received at a second handheld device 302.

In further embodiments, the communications link 304 can be embodied in other types of communications media. For example, the communications link 304 can be an optical link between two handheld devices 302, or can be a wired or wireless electrical link. Additional possibilities for the network 302 are possible as well.

FIG. 4A shows a second exemplary communications network 400 in which aspects of the present disclosure can be implemented. The communications network 400 is intended to illustrate the point made above; namely, that various types of devices can communicate using any of a variety of types of communication links, or a mixture thereof. One example of such a link is an at least partially audible sound network. The network 400 includes a communication link 402 interconnecting a variety of devices, such as a personal computer 404, a personal digital assistant 406, a cellular telephone 408, or a handheld memory device 410. Additional devices are possible as well. In various embodiments, the communication link is a standard of communication allowing communication by various wired or wireless media, such as a sound wave communication link, infrared communication link, wireless (RF) communication link, or wired communication link.

Any of the devices 404-410 can communicate with any of the other devices over the communication link 402, such as by using the systems disclosed above in FIGS. 1-2. Further, when one device transmits information the remaining devices can all sense that information when placed within range that those other devices can audibly, electrically, optically, or otherwise detect the sound emitted from the first device.

FIG. 4B shows a further exemplary communications network 450 in which aspects of the present disclosure can be implemented. The communications network 450 is arranged to illustrate a method of accessing files for which pointers are passed among data communications devices. The communications network 450 uses a standard internet connection 452 connecting a personal computing system 454 with a server system 456 to access files referenced on a data communications device, such as a USB flash drive. The communications network 450 includes a data communications device, such as the handheld memory device 410 as previously described. The handheld memory device is electrically connected to a personal computing system 454, such as through a USB port. In this embodiment, the handheld memory device 410 can store files and can also store reference identifiers to specific media files. By using such an embodiment of the system, the various handheld memory devices described herein can transmit either files or can transmit pointers to those files that are stored remotely, such as on a server system 456. When the pointer is transmitted between two devices, a user of the device to which the pointer is transmitted can then access the data by connecting the handheld memory device 410 to a computing system (e.g. computing system 454) and accessing the file stored on the server 456 by reference to the pointer stored on the device.

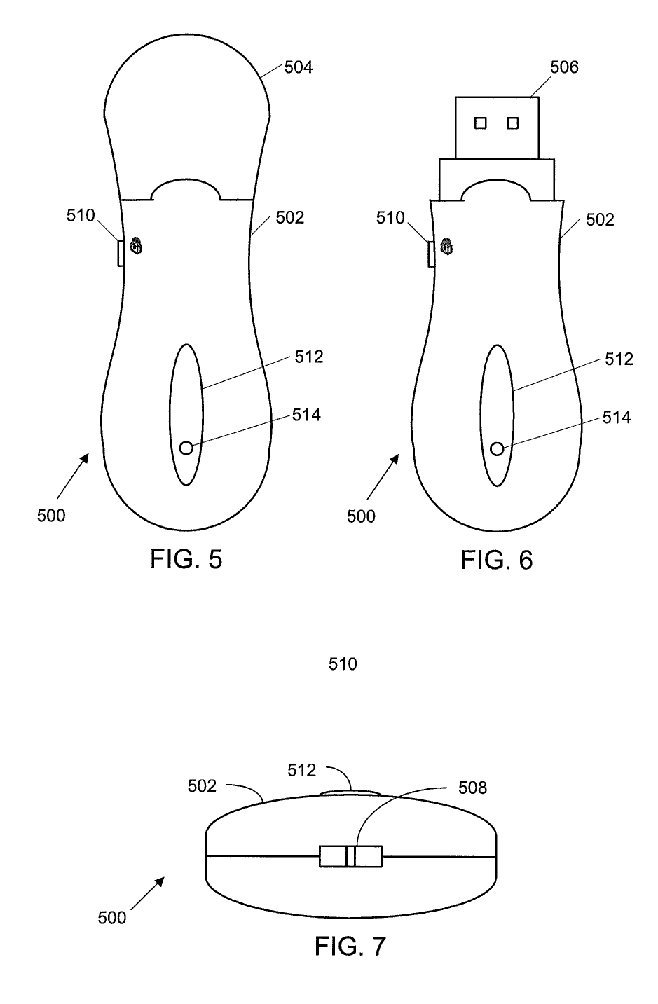

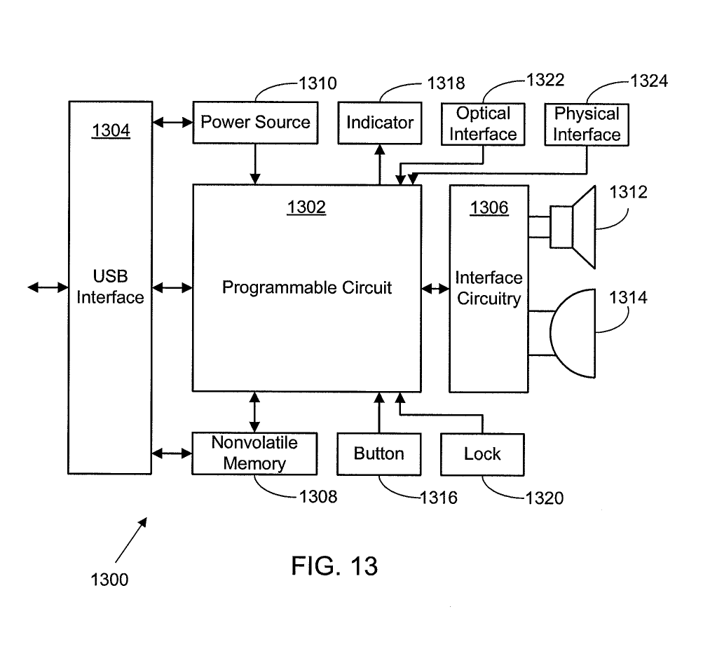

FIGS. 5-7 show a data communications device 500 according to a possible embodiment of the present disclosure. The data communications device 500 is one example of a handheld device in which the systems of FIGS. 1-2 can be implemented. The device 500 incorporates one or more of various audible, electrical, and optical data transmission/receipt features with data storage and transmission features, as described below and in conjunction with FIG. 13.

The data communications device 500 includes a housing 502 configured to fit in the hand of a user. The housing 502 can be manufactured from any of a variety of substantially rigid materials, such as plastic or metal. The housing 502 is contoured to fit the hand of a user, with a narrow center portion and flared ends.

The housing includes a cover 504 at a top end of the housing to protect an electrical interface 506, seen in FIG. 6. In the embodiment shown, the electrical interface 506 is a Universal Serial Bus (USB) interface configured to be plugged into a USB port for data and power transfer between the device 500 and other computing equipment, such as a personal computer. The electrical interface 506 can be configured to interface with a nonvolatile memory residing within the interior of the housing 502, such as a flash memory or miniaturized hard drive configured for data storage. Additional circuitry can be included within the housing as well, and can be externally connected to other electronic/computing equipment via the electrical interface 506.

In a possible embodiment, the electrical interface has a top edge that is curved to be outwardly convex (shown as a flat edge in FIG. 5), which may be considered more ergonomically pleasing if required to be held near the ear of an individual using the device 500. Other shapes are possible as well.

A port 508 at the base end of the housing 502 allows sound, light or radio waves to enter and exit the housing 502 of the device 500. The port 508 optionally includes two openings. In the case that the port is used for audible communication, one of the openings can be configured to transmit audible sounds and one can be configured to receive audible sounds. In the case that the port is used for infrared or other optical transmissions, one opening or optical connection can be used for an LED or other optical transmitter, while another opening can be related to a photodetector or other optical receiver. Other configurations of the port are possible as well, generally relating to the method/medium of transmission of data.

Additionally, a second port can be integrated into the electrical interface 506 at the top end of the device 500, such that the send and/or receive functions produce audible sounds emitted from the portion of the device 500 including the electrical interface 506. In one embodiment, both the send and receive functions are located at the end of the device 500 including the electrical interface 506. In a second embodiment, one of the send and/or receive functions occurs at the electrical interface 506 and the complementary function occurs at the port 508. In a further embodiment, both functions occur at both locations.

A lock switch 510 located along a side edge of the housing 502 allows a user to selectively lock the device 500 such that one or more functions of the device 500 is deactivated. In one embodiment, the lock switch 510 deactivates the electrical interface 506, preventing data communication with external computing devices. In a further embodiment, the lock switch 510 deactivates at least one of the send and/or receive functions of the device 500, such that various extraneous sounds are not perceived by the device to be data transmission. Combinations of these functions, or multiple lock switches, are possible as well.

An activation button 512 located along a front face of the housing 502 activates data transmission via an audible signal. A user, by depressing and optionally holding down the activation button, activates a method of audibly transmitting digital data, such as the method described above in conjunction with FIG. 2. An indicator 514 embedded within the activation button 512 indicates to the user when digital data has been successfully sent or received. Example uses of the indicator 514 are discussed above in connection with FIGS. 1-2.

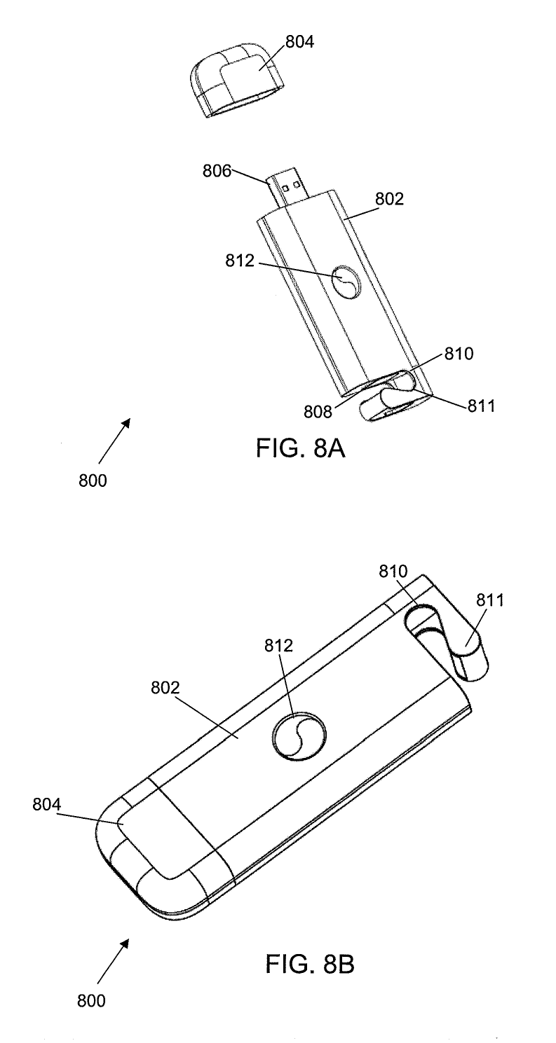

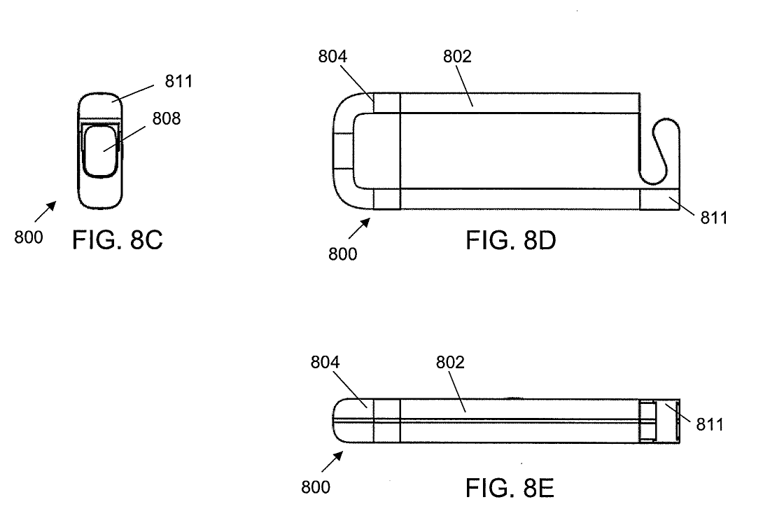

FIGS. 8A-8E illustrate a data communications device 800 according to a further embodiment of the present disclosure. The data communications device 800 can generally incorporate the various features of the device shown in FIGS. 5-7 above; however, in certain embodiments, additional or different methods of communication can be employed. In the embodiment shown, the data communications device 800 includes a housing 802 and a cover, shown as cap 804, configured to fit over and protect an electrical interface, such as the USB connector 806.

In the embodiment shown, the device 800 includes a port 808 for communication with another like device. The port 808 is shown as an infrared data communication port; however, in various other embodiments of the present disclosure, the port can provide a direct wired or audible data communication system. In certain embodiments, the port 808 provides bi-directional communication between devices; in further embodiments, the port provides two-way unidirectional (e.g. half-duplex) communication according to any of a number of formats, as described below.

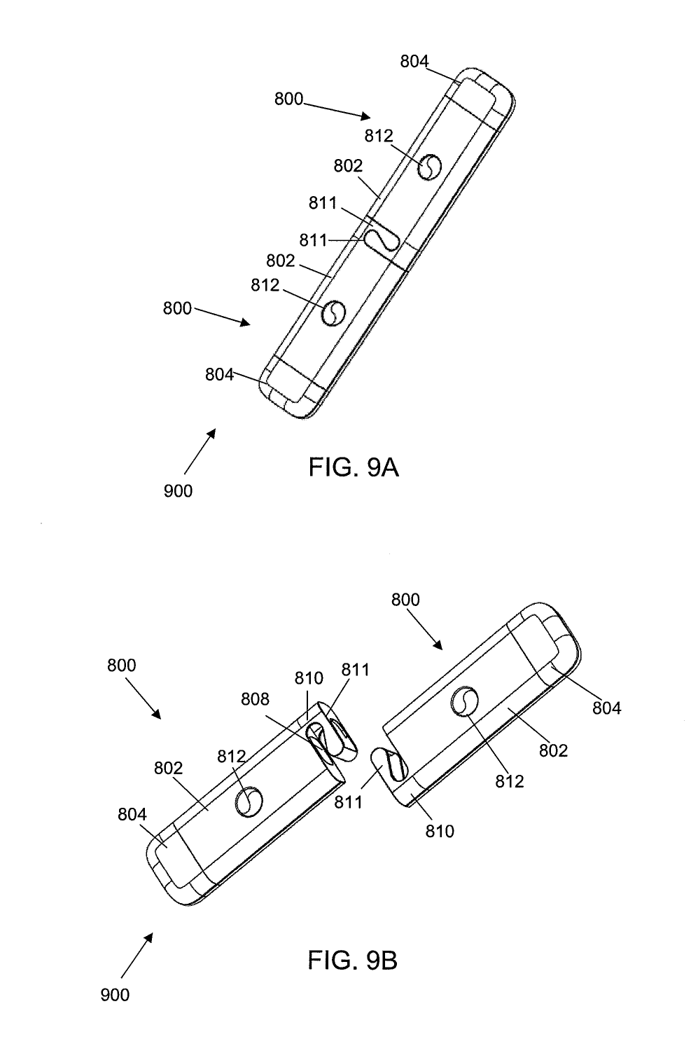

The housing 802 is configured in a “keyed” manner around the port 808 such that two ports only connect together in a single orientation that corresponds with aligning the input and output ports of the device with the output and input ports, respectively, of another device. In the embodiment shown, the housing 802 includes an interconnect structure 810 extending past the port 808 and configured to mate with a complementary structure on another device. The interconnect structure 810, as shown, includes a tab 811 extending past the port 808 and arranged to connect to a complementary tab on another device 800 by laterally sliding the two devices together. The tab 811 includes an opening arranged to allow infrared signals or other types of signals (depending upon the specific configuration of the communication system using the port 808) to pass from one device to another when interconnected. A device-to-device communication system 900 illustrating the orientation and connection of two such devices 800 is shown in FIGS. 9A and 9B. When connected, the joined interconnect structures 810 of the two devices 800 form a surrounding wall around two facing ports 808, the wall formed by the interconnection of the tabs. This wall isolates the ports 808 of joined devices from environmental interference.

The device 800 also includes a button 812 centrally located on a side of the housing. The button 812 activates data communication of the device 800 through use of the port 808. A user will generally choose to press the button on one or both devices when two devices are interconnected, such as is shown in FIG. 9A. In certain embodiments, the button 812 is configured to be pressed to either send or receive data; in other embodiments, the button need only be pressed to send data, with data receipt detected automatically by the complementary connected device.

The embodiment of the device 800 can optionally include additional functionality, such as a power switch or lock switch as shown in FIGS. 4-7. Furthermore, in other embodiments added ports may be included to allow both infrared and another type of data communication, such as a wired or audible data communication or an RF data communication system.

In the embodiment shown, the port 806 is located on an opposite side of the housing from the electrical (e.g. USB) interface. In certain other embodiments, the cap 804 includes a port, such as port 808, allowing the device 800 to communicate through the port by connecting the port to the electrical interface (e.g. via connection to the USB connector 806).

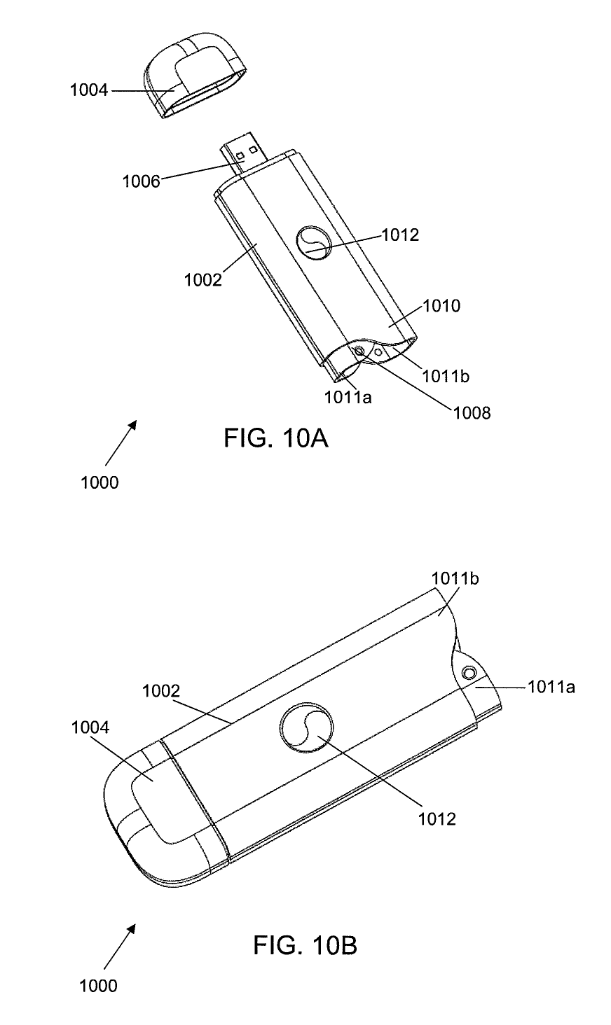

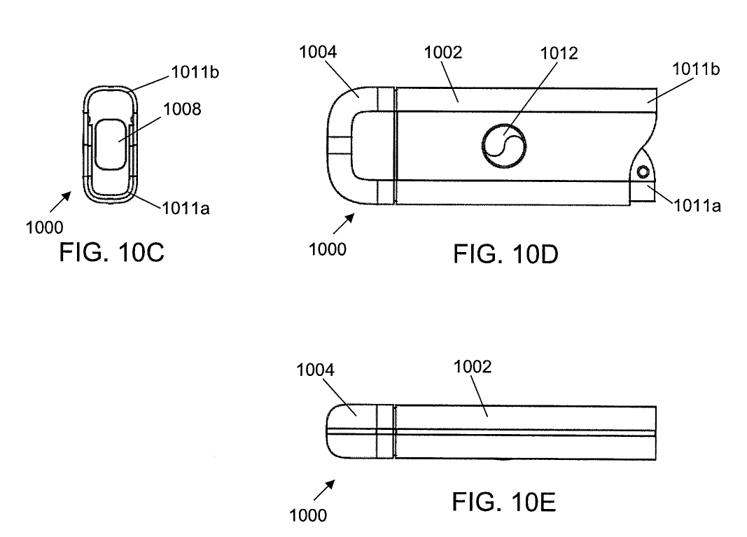

FIGS. 10A-10E illustrate a further embodiment of a data communications device 1000. The data communications device 1000 generally corresponds to the device 800 of FIGS. 8A-8E, and has a housing 1002, cover 1004, electrical interface (shown as USB interface 1006), and a port 1008. These components generally correspond to like-numbered components of FIGS. 8A-8E, above. However, in the embodiment shown, the housing 1002 is formed to provide a different interconnect structure 1010 which two flanges 1011a, 1011b placed along a portion of the perimeter around the port 1008 are arranged to interlock using a friction-fit connection. The two flanges include an inner flange 1011a and an outer flange 1011b, arranged to interlock in a friction-fit or snap-fit configuration. When the two data communications devices 1000 are connected, communications ports 1008 face each other to facilitate direct port-to-port communication. A button 1012, analogous to the button 812, is included in the device 1000 and is centrally located on a side of the housing 1002.

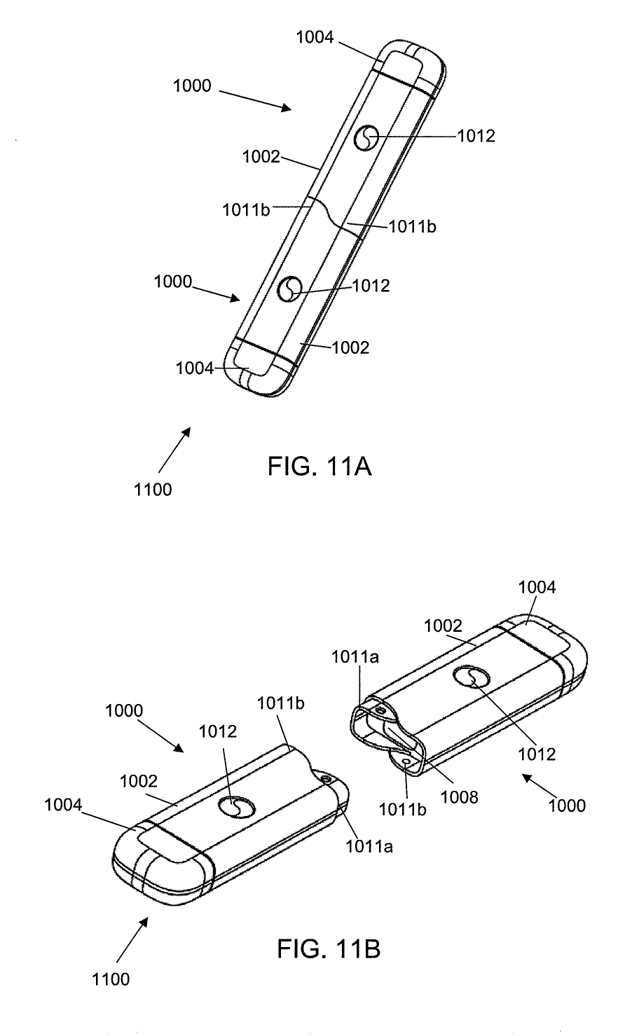

A system 1100 in which two devices 1000 are interconnected in a proper orientation is shown in FIGS. 11A and 11B. When connected, the system 1100 forms a surrounding wall around two facing ports 1008, the wall formed by the interconnection of the flanges 1011a-b on both devices 1000.

The embodiment of the device 1000 can also optionally include additional functionality, such as a power switch or lock switch as shown in FIGS. 4-7, or the other features discussed in conjunction with FIGS. 8-9. Furthermore, in other embodiments added ports may be included to allow both infrared and another type of data communication, such as a wired or audible data communication or an RF data communication system.

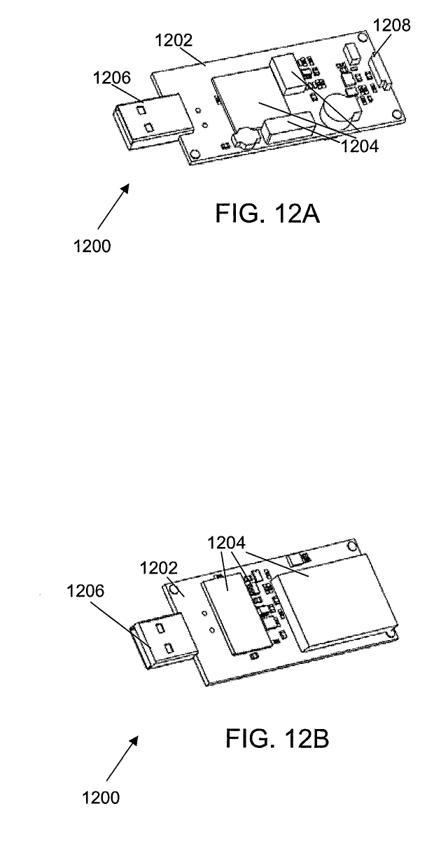

FIGS. 12A and 12B illustrate front and rear perspective views of example circuitry 1200 useable in the data communications devices of FIGS. 5-11, according to a possible embodiment of the present disclosure. In this embodiment, the circuitry 1200 generally provides the functionality of a USB flash drive device, in that it includes a nonvolatile memory and USB interface to that memory. The circuitry 1200 includes a printed circuit board 1202 upon which a variety of circuitry 1204 is mounted. The circuitry 1204 generally includes the nonvolatile memory and a programmable circuit able to execute firmware that executes the various methods and systems described in FIGS. 1-2, above. In various embodiments, the circuitry 1204 can include, for example, various circuitry configurations such as the example circuitry arrangements shown in FIGS. 13-14 and FIG. 18, below.

An electrical interface, shown as USB connector 1206, is connected at one edge of the printed circuit board 1202, and is interfaced to the circuitry 1204 to allow data communication between the circuitry (and nonvolatile memory included therein) and a computing system electrically connected to the interface. A port 1208 located on an edge of the printed circuit board 1202 opposite to the USB connector provides a second method of communication to share data stored in at least a portion of the nonvolatile memory. The port 1208 can communicate via a variety of media, such as by using sound waves, infrared or other optical communication, radio/wireless communication, or by direct electrical connection.

In certain embodiments, although the entirety of the nonvolatile memory can be accessed using the USB interface 1206, only a portion of the memory is accessible via data communication using the port. In this sense, a portion of the data stored in the nonvolatile memory is “private” (i.e. inaccessible via communication with the port) and a portion is “public” (accessible via the port).

FIG. 13 shows an exemplary schematic of circuitry 1300 of an audible data communications device according to a possible embodiment of the present disclosure. The circuitry 1300 can be implemented, for example, in the device 500 shown in FIGS. 5-7 or the other devices 800 and 1000 shown in FIGS. 8-11, as shown in the circuitry of FIGS. 12A and 12B. Alternately, the circuitry can be implemented in a cellular telephone, personal digital assistant, or other handheld or portable electronics.

The circuitry, in general includes a programmable circuit 1302, an electrical interface 1304, an acoustic interface 1306, a memory 1308, and a power source 1310. The circuitry optionally includes an optical interface 1322 and a physical interface 1324 as well.

The programmable circuit 1302 controls overall operation of the audible data communications device in which it is located. The programmable circuit includes a digital signal processor configured to perform the analog to digital and digital to analog conversions necessary to convert the digital data packets to audible sound.

The programmable circuit 1302 also optionally includes various additional operational logic configured to access memory, and to respond to the various interfaces to the programmable circuit. In one embodiment, the programmable circuit 1302 includes a microcontroller. The microcontroller can be programmable in any of a number of programming languages, such as assembly language, C, or other low-level language. In alternate embodiments, the programmable circuit 1302 includes a programmable logic device (PLD) such as a field programmable gate array (FPGA), Complex Programmable Logic Device (CPLD), or Power ASIC (Application Specific Integrated Circuit). In these embodiments, a hardware description language such as Verilog, ABEL, or VHDL defines operation of the programmable circuit 1302.

The electrical interface 1304 provides an electrical and data connection between the circuitry 1300 and connecting circuitry of an external or additional computing device. In the embodiment shown, the electrical interface 1304 is a USB interface, which allows the system to both (1) transmit and receive data along the interface, and (2) receive electrical power, such as to power the system or charge a power source (i.e., a battery) included in the circuitry 1300.

The acoustic interface 1306 includes various circuit elements that may be necessary, depending upon the chosen implementation of the programmable circuit, to convert the analog signals received from the programmable circuit 1306 and to convert those signals to audible sounds, and vice versa. The acoustic interface includes a transducer 1312 configured to output sounds based on analog signals received from the programmable circuit 1302, and a receiver, such as a receiver 1314, configured to receive sounds and convert those sounds to analog electrical signals recognizable to the electrical circuit. In various possible embodiments, the frequency response of the transducer 1312 allows performance at one or more frequencies, such as from about 200 Hz to about 3400 Hz of standard POTS phone lines, or within the audible bandwidth of a cellular telephone transmission.

The transducer 1312 and receiver 1314 can be arranged in a number of ways to reduce interference between them and prevent sound feedback in the circuitry 1300. In one possible embodiment, the transducer 1312 is located remotely from the receiver 1314, such as at opposite ends of a device in which they are located. In a further possible embodiment, a system incorporating these components may have dedicated ports for each of the transducer 1312 and receiver 1314. In yet a further possible embodiment, the transducer 1312 and receiver 1314 are arranged concentrically to minimize feedback. In such a configuration, the transducer 1312 may be formed in a logarithmic acoustic shape. The receiver 1314 can be directly coupled to a transducer 1312 and formed in a complementary shape to receive directionally oriented sound emitted from a transducer 1312 in a complementary audible data communications device. One or more of these configurations may be used in any one device incorporating the acoustic interface 506.

The memory 1308 can be any of a variety of preferably non-volatile, electrically erasable and reprogrammable memories. In a possible embodiment, the memory 1308 is a flash memory. Other memory technologies are integrable into the circuitry 1300 as well.

The power source 1310 provides electrical power to the circuitry 1300 when the circuitry is not connected to an external power source via the electrical interface 1304. In a possible embodiment, the power source 1310 is a compact, rechargeable battery. The power source can preferably be recharged using the electrical interface as well. However, in a further embodiment, the power source 1310 is replaceable.

The circuitry 1300 also includes an activation button 1316, an indicator 1318, and a lock switch. The activation button 1316 allows a user to activate one or more functions incorporated into the circuitry 1300. In one embodiment, the activation button activates the programmable circuit 1302 and acoustic interface 1306 to cause data stored in the memory 1308 to be transmitted audibly via the transducer 1312. In a further embodiment, the activation button also activates the acoustic interface 1306 to allow receipt of audible sounds at the receiver 1314 and conversion to digital data.

The indicator 1318 provides a visible indication to a user of the status of the device in which the circuitry 1300 is embodied. The indicator can be configured to be activated upon successful audible receipt and/or transmission of the digital data. The indicator can also be configured to indicate when the power source 1310 needs to be replaced, or can indicate a state corresponding to when the electrical interface 1304 is connected to an external electronic device (such as when the circuitry is connected via the USB connection to recharge the power source 1310).

The lock switch 1320 locks one or more of the functions of the circuitry so as to prevent unintentional data transmission/receipt. In one embodiment, the lock switch 1320 activates and deactivates the receiver 1314 or one or more components of the acoustic interface 1306, preventing translation of one or more unintentional sounds to digital data, which would result in storage of extraneous data within the memory 1308. In a further embodiment, the lock switch 1320 activates and deactivates both the receiver 1314 and the transducer 1312, preventing both transmission and receipt of audible data. In still other embodiments, the lock switch 1320 prevents reading from or writing to the memory 1308, or transmission of data along the electrical interface 1304. Combinations of these functions may be implemented with the lock switch 1320 as well.

The optional optical interface 1322 provides an alternate method by which data can be communicated between data communications devices. The optical interface 1322 is configured to send and receive data analogously to the acoustic interface 1306. The optical interface 1322 can be used as a selectable alternative to the acoustic interface 1306 for implementations in which audible sounds are not desired. In one embodiment, the optical interface 1322 is an infrared transmitter/receiver. In such an embodiment, the optical interface 1322 transmits and receives data in all or part of the useable bandwidth provided by the selected infrared transmitter/receiver.

In certain embodiments, the optical interface 1322 can be used in conjunction with the acoustic interface 1306 to transmit data at a higher data rate. In still further embodiments, the optical interface 1322 can completely replace the acoustic interface 1306 and the transmitter 1312 and receiver 1314 in data communications.

The optional physical interface 1324 provides a further alternate method by which data can be communicated between data communications devices. The physical interface 1324 is configured to send and receive data analogously to the acoustic interface 1306 and the optical interface. The physical interface can be used as a further selectable alternative to the other interfaces, such as where the other interfaces are non-operable. In such embodiments, the physical interface can correspond to electrical circuitry and electrical contacts capable of forming a digital or analog data connection between two like devices.

In a possible embodiment, the circuitry 1300, and the electrical interface 1304 in particular, can be used to program the programmable circuit 1302 or to place information into memory 1308 regarding the type and/or size of data to be transmitted (as well as the data itself). In such an embodiment, software may be provided to a user that can be used to access and define the various fields of the data packets or, in general, the data to be transferred.

In a further possible embodiment, the circuitry 1300 is configured such that, upon connection to an external computing device via the electrical interface 1304, data is imported into the memory 1308, such as e-mail messages, contact information, websites, and other personal information collected on a personal computer can be shared between devices including the data transmission systems described herein.

In yet another possible embodiment, the circuitry 1300 is configured such that, upon connection to an external computing device via the electrical interface 1304, data is exported from memory 1308 such that the information held within the memory 1308 is duplicated onto a computing device, such as a personal computer, for further use and distribution.

In still a further possible embodiment, the circuitry 1300 is configured to allow only partial access of data in the nonvolatile memory 1308 to one or more of the interfaces 1306, 1322, 1324 that are not the direct electrical, USB interface 1304. In such an embodiment, a user of a computing system connected to the circuitry 1300 can choose to place files or other data in either a portion of memory accessible via the interfaces (i.e. a public portion of memory) or in a portion only accessible via the USB interface (i.e. a private portion of the memory).

Using the systems disclosed herein, such as the circuitry 1300 implementing methods such as those shown in FIGS. 1-2, it is preferable that the duration of communication between two or more devices be of a limited duration so as to maximize the convenience of the methods and systems for data transfer. It is further preferable that robust communications protocols be used for audible data transfer due to possible signal noise and other interfering effects.

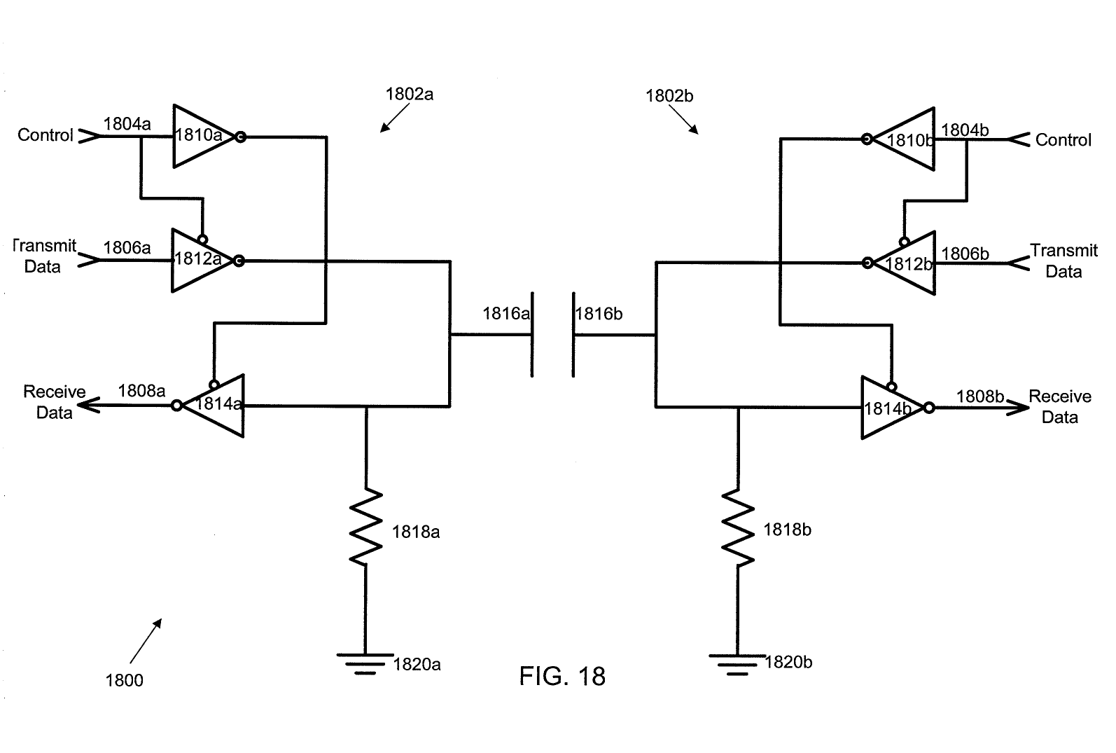

In one possible embodiment, the circuitry operates to transmit data at a 1200 bit per second rate, which is a widely available international data transmission standard. Using this transmission rate allows the systems described herein to transmit a kilobyte in roughly 6-7 seconds (including header information and any of various handshaking algorithms required), and allowing a 300 byte file to be transmitted in about two seconds or less. In certain embodiments, about 150 bytes of data are typically transferred at a time, allowing for about a single second of data transfer. Larger or smaller files require a proportional amount of time for data transmission. To allow larger files to be transferred in a shorter time, higher data transmission speeds can be implemented, such as 2400 bps, 4800 bps, 9600 bps, or the like, using full or half duplex modes of operation. An example of half duplex transmission circuitry is described below in conjunction with FIG. 18.

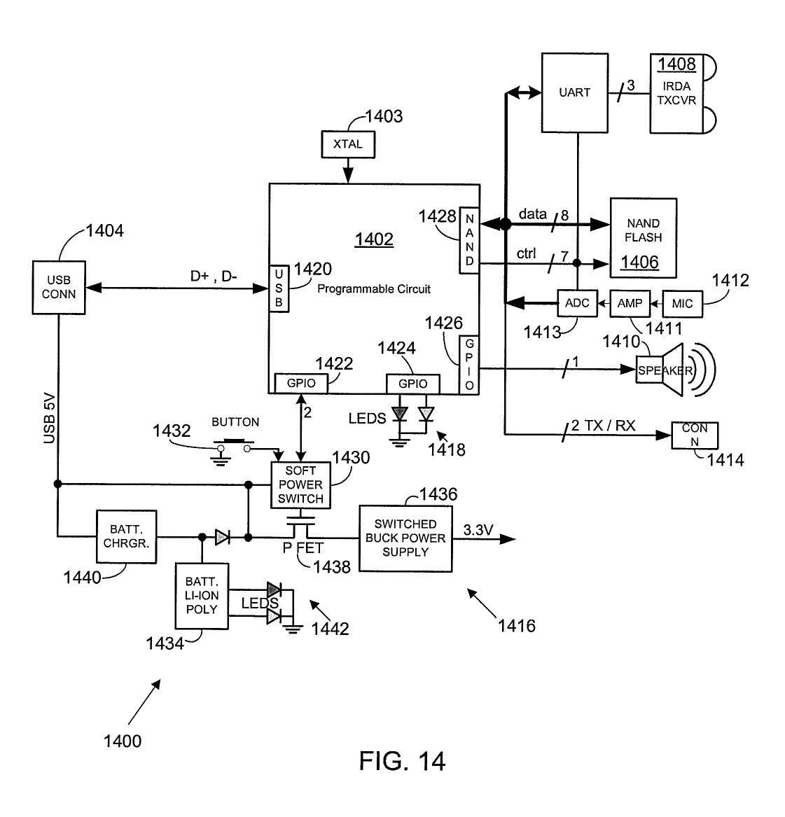

FIG. 14 illustrates a further specific embodiment of circuitry 1400 useable to implement aspects of the present disclosure. The circuitry 1400 can be implemented, for example, in the device 500 shown in FIGS. 5-7 or the other devices 800 and 1000 shown in FIGS. 8-11, as shown in the circuitry of FIGS. 12A and 12B. Alternately, and similar to the circuitry of FIG. 13, above, the circuitry 1400 can be implemented in a cellular telephone, personal digital assistant, or other handheld or portable electronics.

The circuitry 1400 generally includes a programmable circuit 1402, a USB connector 1404, nonvolatile memory 1406, infrared transceiver 1408, speaker 1410, receiver 1412, and a wired connector 1414. The circuitry also generally can include power circuitry 1416 and indicator LEDs 1418. Operation of these components is described in greater detail below.

The programmable circuit 1402 can be any of a number of different programmable logic devices or application-specific logic devices. In a possible embodiment, the programmable circuit 1402 is a programmable logic device, such as a field programmable gate array (FPGA), programmable logic array (PLA), or other similar device. The programmable circuit 1402 is configured to execute firmware instructions to execute various processes within the device. Although the specific processes may vary based on the specific nature of the device, the device will generally include functionality to allow access to the nonvolatile memory 1406 to the USB connector 1404, as well as to the various other input and output interfaces (e.g. the infrared transceiver 1408, speaker 1410, receiver 1412, and a wired connector 1414).

In the embodiment shown, the programmable circuit 1402 includes a variety of input/output ports, including a USB port 1420, three general purpose I/O ports 1422, 1424, 1426, respectively, and a memory access port 1428. Other ports may be included as well. The USB port 1420 is associated with the USB connector 1404, and provides a data connection from the programmable circuit 1402 to the USB connector. Likewise, general purpose port 1422 provides an interconnection to power circuitry 1416, port 1424 provides an interconnection to indicator LEDs 1418, and port 1426 provides a control interconnection to the other data connection interfaces (e.g. the infrared transceiver 1408, speaker 1410, receiver 1412, and a wired connector 1414). A crystal oscillator 1403 provides a clock signal to the programmable circuit 1402, and is also powered from the power circuitry 1416.

In certain embodiments, the programmable circuit 1402 executes firmware to allow only access to a portion of the nonvolatile memory 1406 to the various input and output interfaces that are not the USB connector interface.

The USB connector 1404 provides direct wired interconnection between the circuitry 1400 and a computing system to which the connector is connected. The USB connector 1404 provides a method by which data can be shared between the nonvolatile memory 1406 and the computing system, and can also provide a power connection to power the circuitry 1400 and recharge a power source integrated with the circuitry 1400. The nonvolatile memory 1406 can be any of a variety of types of nonvolatile memory, such as powered RAM, flash memory, or other memory types. In certain embodiments, the nonvolatile memory 1406 is a flash memory device interfaced to the programmable circuit 1402 by a data bus connecting between the memory and the memory access port 1428 of the programmable circuit 1402. In the embodiment shown, the memory access port is a NAND-configured memory access port configured to request and receive data from NAND type flash devices. In other embodiments, the port 1428 can be configured to access NOR-type flash devices.

The infrared transceiver 1408 provides full- or half-duplex data communication between the circuitry 1400 and an external device, such as another device incorporating such circuitry. An example of half-duplex data communication circuitry is described below in conjunction with FIG. 18. In the embodiment shown, the infrared transceiver operates at 4 Mbps in a half-duplex mode.

The speaker 1410 and receiver 1412 provide functionality for audible communication to the circuitry 1400, and also provide a method of indicating to a user that communication is taking place. For example, the speaker 1410 can be used to transmit audible signals that can contain audible data packets containing encoded digital data. The receiver 1412, conversely, can receive audible signals that contain audibly encoded digital data. Additionally, when the speaker 1410 and receiver 1412 are not used to transmit or receive data, they can be used by the circuitry 1400 to transmit information to the user by emitting sounds recognizable to the user (e.g. confirmation beeps, recorded messages, and other sounds). For example, the speaker can emit sounds corresponding to various data sharing tasks as they occur, such as powering on the data communications device, detecting another device, initiating data communication, confirming successful data communication, powering down, or other tasks.

In certain embodiments (such as the one shown), the receiver 1412 is a microphone interconnected to an amplifier 1411 and an analog-to-digital converter 1413, which act in combination to amplify sounds detected at the receiver and to sample those sounds for processing in the programmable circuit 1402. Other circuitry arrangements are possible as well.

The wired connector 1414 can provide a further method of communication between two similar devices (as in FIGS. 9A and 9B and FIGS. 11A and 11B, above) providing a direct electrical interface between two similar devices when connected in the proper orientation. In various embodiments, the wired connector 1414 can be a single pin serial connection, differential signal connection, or parallel connection configured to transfer data between two data communications devices.

The power circuitry 1416 includes a power switch 1430 interconnected to the general purpose port 1420. The power switch 1430 is activated by a button 1432 that allows the switch to activate, thereby completing a circuit for use with a battery 1434, an external power supply 1436 interconnected with the system, or through the USB connector 1404. A PFET switch 1438 allows selection of the battery 1434 and USB connector 1404 or the power supply 1436. The USB connector 1404 is further interfaced with a battery charger 1440 that can recharge the battery 1434 when the circuitry 1400 is interconnected with a computing system. Optionally, LEDs 1442 indicate the powered status (needs recharging, currently charging, charged, low power, etc.) of the battery 1434.

FIGS. 15-17 show exemplary data packets that can be communicated using the methods and systems described herein. FIG. 15 shows a first data packet 1500, which includes a number of start bits 1502, and a number of predetermined fields 1504a-e. The start bits can represent bits used by the system to determine the size and/or structure of the data packet, and can otherwise include other “header” information regarding the data packet and data file as a whole (which may be split among one or more data packets). The predetermined fields 1504a-e are shown to include a name 1504a, address 1504b, title 1504c, phone number 1504d, and email address 1504e, respectively, representing the typical information provided on a business card. Additional information can be included as well.

FIG. 16 shows a second data packet 1600 similar to the first data packet 1500 of FIG. 15, but including various alternate predetermined fields 1604a-d, including a name 1604a, address 1604b, phone number 1604c, and pointer 1604d. These data fields may be programmed by a user, or may represent various fields from, for example, an e-mail message selected for audible, optical, or wired transmission. The pointer 1604d can be used, for example in the network 450 of FIG. 4B, to access a media file or other type of file or message intended for the recipient of the pointer.

FIG. 17 shows a further data packet 1700 similar to the data packets of FIGS. 15-17, but includes customizable fields 1704a-c in combination with the start bits 1702. The customizable fields 1704a-c can vary in length or content, and depend upon the data selected for transmission using the systems described herein. The customizable fields 1704a-c may be defined using a tool provided on a personal computer connected to a handheld device, such as by using the electrical interface 1306 of FIG. 13. Additional methods of defining the customizable fields 1704a-c are possible as well. Further, more or fewer customizable fields can be incorporated into a data packet, and may be implemented in combination with predetermined fields such as those shown in FIGS. 15-16.

Referring now to FIGS. 15-17 generally, the start bits may or may not be present in any data packet, depending upon the particular implementation used for digital data transmission. Additionally, the start bits in any specific data packet may vary in number and content, based on the specific protocol used and data transmitted. Furthermore, the overall length of a given data packet may vary, depending on these or other factors.

Additionally, other types of information can be transmitted according to the principles of operation of the present disclosure, and the examples of FIGS. 15-17 are intended to be exemplary, and not limiting. Additional examples of data that may be transmitted according to the present disclosure include documents, text files, e-mail messages, multimedia files, and other digital data. Specific examples of such data can include video game information, such as configuration files or other shareable video game information. Further examples can include financial information, such as bank account or credit card information, including the number, expiration date, security code, or other information associated with an account. Other examples include personal information, such as a name, social security number, birth date, or other information. Additional types of information can be transmitted according to the present disclosure as well.

FIG. 18 illustrates interface circuitry 1800 for two communicating data communications devices, according to a possible embodiment of the present disclosure. The circuitry 1800 provides an example of a single pin, half-duplex interface useable for connecting two data communications devices 1802a-b, such as for use in a wired or optical data connection. The circuitry 1800 generally includes three signals per device—a control signal 1804a-b, a transmit signal 1806a-b, and a receive data signal 1808a-b, with the signal corresponding to the data communications device with which it is associated. An inverter 1810a-b is connected to the control signal, and the inverse signals generated from the control signal 1804a-b are connected to tri-state buffers 1812a-b, 1814a-b connected to the transmit signals 1806a-b and receive signals 1808a-b, respectively. For example, in device 1802a, the control signal 1804a is connected to the tri-state buffer 1812a that buffers data from the transmit signal 1806a, while the inverse signal from the inverter 1810a provides a control connection to the buffer 1814a connected to the receive signal 1808a.

The output of tri-state buffers 1812a-b connected to transmit signals 1806a-b are joined to the input end of the tri-state buffers 1814a-b leading to receive signals 1808a-b, respectively, at a connector 1816a-b. The joining of the connectors 1816a and 1816b forms the connection between the two devices 1802a-b. Additionally, a resistor 1818a-b is connected between each connector 1816a-b, respectively, and a local ground 1820a-b. In certain embodiments, the resistors 1818a-b are each 100 kiloohm resistors.

In operation, one of the devices will be in a transmit mode, while the other device will be in a receive mode, or vice versa. The devices are placed in that mode by the programmable circuit or other portion of circuitry described in FIGS. 13-14, above, generating a control signal that will activate the transmit data buffer of that device. For example, if device 1802a is in a transmit mode and device 1802b is in a receive mode, a logic “1” control signal will be input on control signal 1804a while a logic “0” control signal will be input on control signal 1804b. In device 1802a, the logic “1” control signal will activate the tri-state buffer 1812a, and its inverse (logic “0”) output from the inverter 1810a will deactivate the tri-state buffer 1814a. Therefore, in device 1802a, data can be transmitted from the buffer 1812a, but cannot be received in the buffer 1814a. Conversely, device 1802b will output a logic “0” control signal, disabling the tri-state buffer 1812b connected to the transmit signal 1806b, while enabling the tri-state buffer 1814b connected to the receive signal 1808b, completing the connection between transmit signal 1806a and receive signal 1808b.

If device 1802b is communicating to device 1802a, oppositely configured control signals can reverse the flow of data passing between the devices. In certain embodiments, one or both devices may be placed by default in a logic “0” control state, enabling receipt of data but preventing output of data on the single pin connection. Other embodiments implementing different defaults or different numbers of contacts are possible as well.

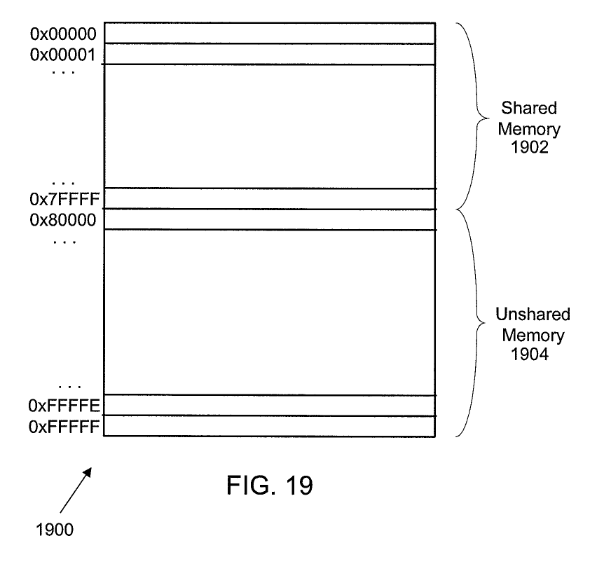

FIG. 19 illustrates a block of nonvolatile memory 1900 segmented into shared and private sectors, according to a possible embodiment of the present disclosure. The nonvolatile memory 1900, as shown, can be a byte-addressable portion of flash memory having 20-bit unique addresses, allowing for 2 GB of memory to be addressed. More or less memory can be incorporated in various other embodiments; the particular bit or byte addressing schemes and capacity of memory used is dictated in part by design choice of the nonvolatile memory and the capacity addressable by a selected programmable circuit interfacing with that memory.

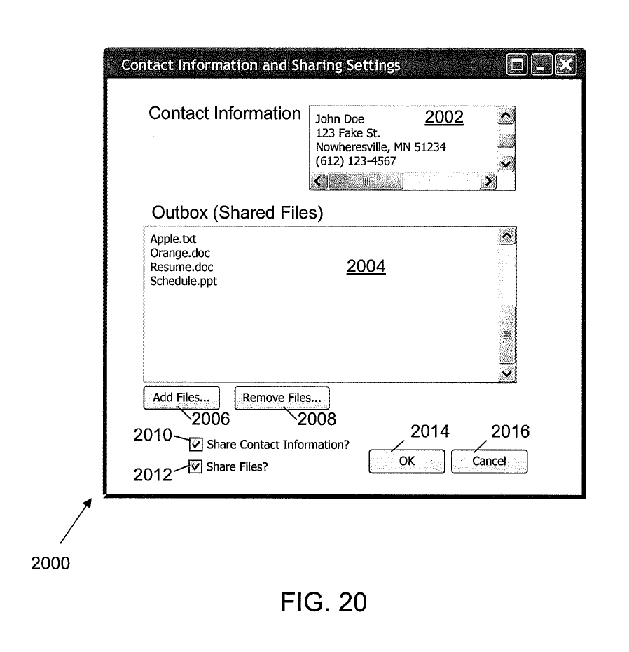

The nonvolatile memory 1900 is separated into two segments, shown as segments 1902 and 1904. The segments 1902 and 1904 can represent, in various embodiments, a public sector of memory and a private sector of memory, in which the public sector is fully accessible via all communications interfaces of a device, while the private sector is only accessible via a trusted, direct wired communication connection with the device (e.g. only through a USB connector interface). As shown in the figure, segments 1902 and 1904 are equal in size (each 1 GB in size), corresponding to equally-sized private and public memory sections for access by the various interfaces connecting to the data communications devices in which the memory is incorporated. Furthermore, the size and arrangement of the memory segments can be adjusted by a user of a data communications device through operation of its firmware. In one embodiment of the data communications device, the firmware includes instructions for transmitting instructions to a computing system upon connection thereto for generating a user interface, such as the user interface of FIG. 20, below. Such a system can allow a user of the device to adjust the sizes and arrangement of the sectors 1902, 1904 upon connection of the data communications device to a computing system.

Although in the present disclosure, two sectors 1902, 1904 are shown, additional sectors can be included in the memory, and can correspond to specific levels of security within the device. For example, one sector can be completely available via all communication interfaces of a data communications device, while another sector is only available to certain interfaces, while a third sector may only be available if proper user credentials are supplied. Additional criteria for access to the data in the memory 1900 may be implemented as well.

FIG. 20 illustrates an example user interface 2000 generated on a computing system for setting user information and file sharing information according to a possible embodiment of the present disclosure. The user interface 2000 allows a user of a data communications device, as described herein, to set information that will be shared with other data communications systems upon connection and initiation of a communications process as described in FIGS. 1-2 and FIG. 22, below. For example, the user interface 2000 can allow a user to enter business card information or other contact information, alongside media files, business card files, or other types of files or information that will be transferred between data communications devices.

The user interface 2000 includes a variety of fields that indicate the information that will be shared by the data communications device with another device to which it can connect. The fields include a user information field 2002, as well as a file listing field 2004 that operates in connection with an add files button 2006 and a remove files button 2008. The user information field 2002 allows the user to enter contact information relating to the user to allow exchange of personal “business card” type information about that user. The file listing field 2004 lists files that can be exchanged in conjunction with the personal information added into the user information field 2002. The add files button 2006 and remove files button 2008 allow the user to add or remove files from the file listing field 2004, respectively.

Check boxes 2010 and 2012 allow the user to select to transmit and share certain portions of the information selected using the user interface 2000. Check box 2010 allows the user to select to share the contact information entered into the user information field 2002. Check box 2012 allows the user to select to share the contact information entered into the file listing field 2004.

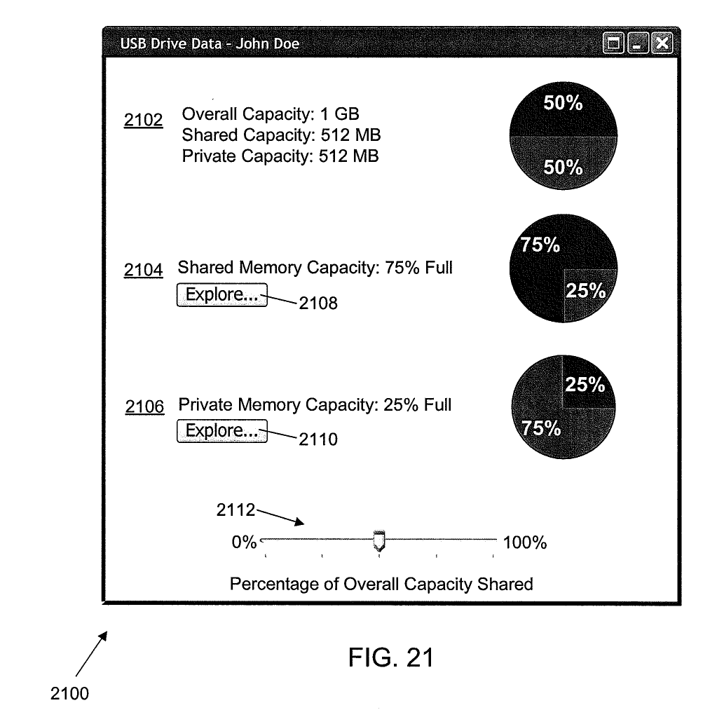

An OK button 2014 and a cancel button 2016, respectively, allow the user to either save the changes made to the user information entered into the user interface 2000 or cancel changes made in the user interface. In certain embodiments, one or both of these buttons allow the user to proceed to the user interface 2100 of FIG. 21, below. Furthermore, in various embodiments, other arrangements of the features disclosed in the user interface are possible as well, and additional features may be added.

Referring now to FIG. 21, an example user interface 2100 generated on a computing system interconnected with a data communications device is shown, according to the various embodiments of the present disclosure. The user interface 2100 allows a user to view and control the partitioning of memory for public and private data collections, as is allowed for in certain embodiments.

The user interface 2100 includes a plurality of indicators relating to the capacity of the data communications device (e.g. the USB flash drive device) and the capacity of the various sectors available in the device. In the embodiment shown, the user interface 2100 includes an overall capacity indicator 2102, as well as a shared sector capacity indicator 2104 and a private sector capacity indicator 2106. Additional or fewer sector capacity indicators are possible as well.

The overall capacity indicator 2102 displays the overall capacity of memory and percentage of memory allocated to the various sectors in the device. The shared sector capacity indicator 2104 displays the percentage of the shared memory sector (e.g. shared memory sector 1902 of FIG. 19, above) that is available and the percentage that contains data. Likewise, the private sector capacity indicator 2106 displays the percentage of the private memory sector (e.g. private memory sector 1904 of FIG. 19) that is available and the percentage that contains data. Each of the sector capacity indicators 2104, 2106 includes an explore button 2108, 2110, respectively. User selection (e.g. clicking with a mouse) of the explore button launches a file explorer window displaying the contents of memory in those sectors in a file and directory format known to those of skill in the art.

In certain embodiments, the explore button 2108 relating to the shared sector capacity indicator 2104 can allow a user to set specific data to be shared with other data communication devices. For example, the explore button 2108 can lead to the user interface 2000 of FIG. 20, described above. In certain further embodiments, the explore button 2108 can lead to an inbox or outbox configured to hold contact information and files received from other users (as well as that user's contact information and files) in a manner consistent with any of a variety of email client programs, such as Microsoft's Outlook email program or IBM's Lotus Notes email program. For various other sectors, different user interfaces may be used as well.

A slider bar 2112 allows the user to dynamically allocate more or less memory to the shared and private memory sectors, respectively, by allowing the user to slide the bar between “completely shared” and “completely private” positions. Additionally, the user can reallocate specific files as shared or unshared, or can alter the percentage of the memory that is shared or private, by dragging and dropping files between file explorer windows generated when pressing the explore buttons 2108, 2110, respectively.

Additional methods of allocating files to shared or unshared sectors of memory are possible as well. In certain embodiments, the files are designated as “shared” or “private” upon storage in the nonvolatile memory of the device by various rules. For example, files stored in the memory that are received via the USB connection to a computing system would be noted as “private” while files received via other communication connections (audible, optical, or wired) could be noted as “public”. A user viewing, for example, a file explorer window could change the designation of the file between “public” and “private”, indicating that the file will or will not be shared upon connection of the device to either another device (e.g. for “public” files) or to a computing system connected to by the USB connector (e.g. for both “public” and “private” files). Further methods or systems are possible as well. One possible method of transmitting shared or unshared files is disclosed in the method of FIG. 21, described below.

In certain embodiments, the various sectors of the memory that are explored contain databases for receiving information from other devices, and from computing systems interconnected with such devices. In further embodiments, the files can be stored in the native format of the files.

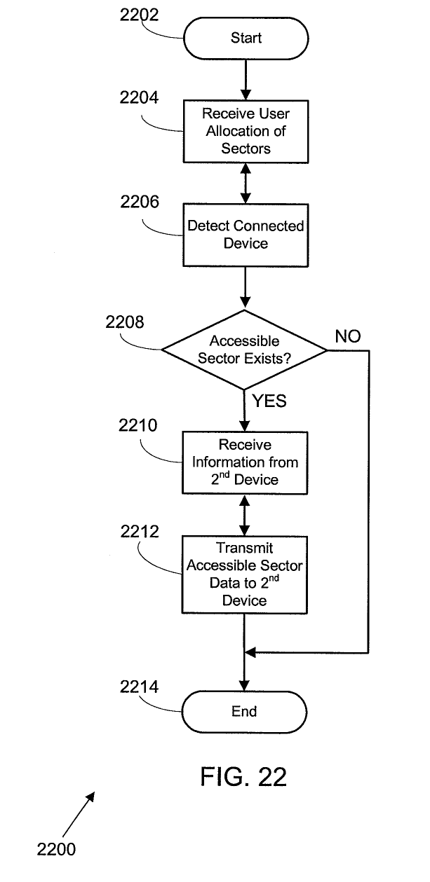

FIG. 22 illustrates a flowchart of methods and systems for sharing data in a sector of memory of the various data communications devices of the present disclosure. The methods and systems 2200 shown provide a process by which data from a particular sector can be shared with corresponding data communications device. For example, the data shared in certain sectors of a device can be exchanged when another such device, which is designated to receive that data, is detected. The system 2200 is instantiated at a start operation 2202. Operational flow proceeds from the start operation to a sector allocation module 2204. The sector allocation module 2204 corresponds to receiving user allocation of memory in the data communications device relating to sharing of data among devices according to the various interfaces available. For example, the sector allocation module 2204 can correspond to receipt of instructions from a user via the user interface of FIG. 21, above. Other methods of receipt of sector allocation instructions are possible as well.

Operational flow proceeds to a device detection module 2206. The device detection operation corresponds to detection of another device interconnected with the data communications device, such as is shown in FIGS. 4, 9A-9B, and 11A-11B. The device detection module 2206 verifies that another device is present, such as by sending out a test data message or otherwise attempting a handshaking operation and receiving confirmation from the second device that the handshaking or other connection confirmation is successful. In certain embodiments, the device detection module is initiated by pressing a soft key on one or more of the data communications devices, according to the various embodiments described herein.

Operational flow proceeds to a sector validation operation 2208. The sector validation operation 2208 determines whether a sector exists that is accessible to a second device, and whether any data exists in that sector for exchange with an interconnected device. In a possible embodiment, the sector validation operation 2208 corresponds to determining the existence of a public sector and optionally also determining that some contents are stored in that sector or memory for exchange. If an accessible sector exists, operational flow branches “yes” to a data receipt module 2210, operation of which is described below. If no accessible sector exists, operational flow branches “no” to an end operation 2214, which corresponds with a completed (and in this case, failed) attempt to exchange data between data communications devices.

The data receipt module 2210 corresponds generally to the methods and systems for receiving data in a data communications device, such as are described above in conjunction with FIG. 1. However, it is understood that the data receipt module 2210 generally limits the data received to data from the second device that is in an accessible sector of that device (e.g. the data that is designated using firmware such as is described in FIG. 20, above), and is also limited by the available non-occupied space allocated to the determined-to-be accessible sector of the receiving device.

Operational flow proceeds from the data receipt module 2210 to a data transmit module 2212. The data transmit module 2212 generally corresponds to methods and systems for transmitting data, as are described above in conjunction with FIG. 2. However, as with the data receipt module 2210, it is understood that the data transferred is generally limited to the data (e.g. the non-duplicate data or predesignated files and contact information) stored in the accessible sector, as determined in the sector validation operation 2208.

Through use of the data receipt module 2210 and data transmit module 2212 it can be seen that two interconnected data communications devices can exchange data that is stored in mutually accessible sectors of memory within those corresponding devices. This “shared” data can easily be passed among a variety of such data communications devices, either in a one-file-at-a-time or a full memory exchange manner.

Operational flow proceeds from the data transmit module 2212 to the end operation 2214, which in this case corresponds to successful linking and exchange/synchronization of data between data communications devices.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A method of transmitting digital data between two USB memory devices each having a USB interface and a secondary communication interface, the method comprising:
aligning the secondary communication interface of a first USB memory device with the secondary communication interface of a second USB memory device;
triggering communication between the first and second communication devices;
retrieving information from a memory of the first USB memory device; and
transmitting the information from the first USB memory device to the second USB memory device via the secondary communication interface.

2. The method of claim 1, wherein aligning the secondary communication interface of the first USB memory device with the secondary communication interface of the second USB memory device includes interconnecting an alignment feature of the first USB memory device with an alignment feature of the second USB memory device.

3. The method of claim 1, wherein the secondary communication interface is an interface selected from the group consisting of:
an infrared interface;
an audible interface;
a wired interface; and
a radio frequency interface.

4. The method of claim 1, further comprising receiving in the first USB memory device information from the second USB memory device.

5. A personal data communication system comprising:
a server communicatively connected to one or more computing systems, the server arranged to receive personal data; and
a plurality of personal data communications devices, each device including:
a memory;
a USB interface;
a secondary interface, separate from the USB interface;
a programmable circuit operatively connected to the memory, the USB interface, and the secondary interface, the programmable circuit programmed to:
exchange reference data with another of the plurality of personal data communications devices using the secondary interface; and
upon connection to a computing system via the USB interface, communicatively connect to the server to access the personal data based on the reference data.

6. The personal data communication system of claim 5, wherein the reference data corresponds to a pointer to information stored on the server.

7. The personal data communication system of claim 5, wherein the personal information comprises personal information selected from the group consisting of:
personal contact information;
medical information;
internet addresses;
social security numbers;
birth date information;
email messages;
email addresses;
credit card information;
website links;
game information; and
customized messages.

8. The personal data communication system of claim 5, wherein the secondary interface is an interface selected from the group consisting of:
an infrared interface;
an audible interface;
a wired interface; and
a radio frequency interface.

9. A USB memory device comprising:
a housing sized to fit in the hand of a user;
a memory configured to store personal information;
a USB interface;
a secondary interface, separate from the USB interface;
a programmable circuit operatively connected to the memory, the USB interface, and the secondary interface, the programmable circuit programmed to:
transmit digital data via the secondary interface, the programmable circuit including program instructions to:
retrieve personal information from the memory;
convert the personal information to a digital data packet;
generate an communication signal using a communications protocol, the communication signal based on the digital data packet;
receive digital data via the second interface, the programmable circuit including program instructions to:
sense a communication signal;
translate the communication signal to a digital data packet using a communications protocol;
convert the digital data packet to personal information;
store the personal information in a collection of personal information stored in the memory.

10. The USB memory device of claim 9, wherein the communication signal is an audible communication signal transmitted using sound waves.

11. The USB memory device of claim 9, wherein the communication signal is an infrared communication signal.

12. The USB memory device of claim 9, wherein the communication signal is an electrical signal.

13. The USB memory device of claim 9, wherein the communication signal is a radio frequency signal.

14. The USB memory device of claim 9, wherein the personal information includes a pointer to data stored on a server system.

15. The USB memory device of claim 9, further comprising a power source operatively connected to the programmable circuit, wherein the power source is rechargeable via the USB interface.

16. The USB memory device of claim 9, wherein the secondary interface is an infrared communication interface.

17. The USB memory device of claim 16, wherein the housing includes an interconnecting portion arranged to communicatively align the secondary interface of the USB device with a complementary interface of a second USB device.

18. The USB memory device of claim 17, wherein the interconnecting portion communicatively isolates the secondary interface and the complementary interface from external interference.

19. A handheld memory device comprising:
a housing sized to fit in the hand of a user;
a memory configured to store personal information;
an electrical interface connectable to a personal computer;
a secondary interface, separate from the electrical interface; and
a programmable circuit operatively connected to the memory, the electrical interface, and the secondary interface, the programmable circuit programmed to:
receive information, through the electrical interface, from a user relating to data to be included in first personal information stored in the memory;
transmit digital data via the second interface, the programmable circuit including program instructions to:
retrieve the first personal information from the memory;
convert the first personal information to a digital data packet; and
generate a communication signal using a communications protocol, the communication signal based on the digital data packet; and
receive digital data via the secondary interface, the programmable circuit including program instructions to:
sense a communication signal;
translate the communication signal to a digital data packet using a communications protocol;
convert the digital data packet to second personal information relating to a user of a different handheld memory device; and
store the second personal information in a collection of personal information stored in the memory.

20. The handheld memory device of claim 19, wherein the electrical interface is a USB interface.

21. The handheld memory device of claim 19, wherein the secondary interface is an infrared interface.

22. The handheld memory device of claim 19, wherein the programmable circuit is further configured to generate one or more user interfaces on a computing system connected to the device by the electrical interface, the one or more user interfaces providing a plurality of fields for managing data communication of the device.

23. A method of audibly transmitting digital data in a handheld device, the method comprising:
retrieving personal information from a memory of the handheld device;
converting the personal information to a digital data packet; and
generating an audible signal using a communications protocol based on the digital data packet.

24. The method of claim 23, wherein the collection of personal information comprises a personal information entry selected from the group consisting of:
personal contact information;
medical information;
internet addresses;
social security numbers;
birth date information;
email messages;
email addresses;
credit card information;
website links;
game information; and
customized messages.

25. The method of claim 23, wherein the communications protocol is a modem communications protocol.

26. The method of claim 23, further comprising, in a second handheld device:
sensing the audible signal;
translating the audible signal to a digital data packet using a communications protocol;
converting the digital data packet to personal information; and
storing the personal information in a collection of personal information.

27. The method of claim 26, further comprising confirming that the personal information is stored successfully, wherein confirming that the personal information is stored successfully comprises emitting an audible confirmation sound.
